(19) United States
(12) Patent Application Publication
(10) Pub. No.: US 2026/0082072 A1
(43) Pub. Date: Mar. 19, 2026

(54) SYSTEM AND METHOD FOR HYPERPRIOR-BASED LEARNED VIDEO COMPRESSION WITH RESIDUAL AND CHANNEL ATTENTION NETWORK

(71) Applicant: GUANGDONG OPPO MOBILE TELECOMMUNICATIONS CORP., LTD., Dongguan (CN)

(72) Inventors: Cheolkon JUNG, Dongguan (CN); Yusong HU, Dongguan (CN)

(21) Appl. No.: 19/397,355

(22) Filed: Nov. 21, 2025

Related U.S. Application Data
(63) Continuation of application No. PCT/CN2023/095876, filed on May 23, 2023.

(51) Int. Cl. H04N 19/51; H04N 19/13; H04N 19/137; H04N 19/172; H04N 19/174; H04N 19/176; H04N 19/42

(52) U.S. Cl. CPC H04N 19/51; H04N 19/13; H04N 19/137; H04N 19/42; H04N 19/172; H04N 19/174; H04N 19/176

(57) ABSTRACT

According to one aspect of the present disclosure, a method of video coding is provided. The method may include generating, by a processor, optical-flow information based on a current image area and a reference image area. The method may include inputting, by the processor, the optical-flow information into an entropy-coding network of a motion-compensation network. The entropy-coding network may include at least one Gaussian error linear unit (GELU) layer. The method may include generating, by the processor, a predicted image area as an output of the motion-compensation network.

### CROSS-REFERENCE TO RELATED APPLICATIONS

This application is a continuation of International Application No. PCT/CN2023/095876, filed on May 23, 2023, the disclosure of which is hereby incorporated by reference in its entirety.

### BACKGROUND

Embodiments of the present disclosure relate to video coding.

Digital video has become mainstream and is being used in a wide range of applications including digital television, video telephony, and teleconferencing. These digital video applications are feasible because of the advances in computing and communication technologies as well as efficient video coding techniques. Various video coding techniques may be used to compress video data, such that coding on the video data can be performed using one or more video coding standards. Exemplary video coding standards may include, but not limited to, versatile video coding (H.266/VVC), high-efficiency video coding (H.265/HEVC), advanced video coding (H.264/AVC), moving picture expert group (MPEG) coding, to name a few.

### SUMMARY

According to one aspect of the present disclosure, a method of video coding is provided. The method may include generating, by a processor, optical-flow information based on a current image area and a reference image area. The method may include inputting, by the processor, the optical-flow information into an entropy-coding network of a motion-compensation network. The entropy-coding network may include at least one Gaussian error linear unit (GELU) layer. The method may include generating, by the processor, a predicted image area as an output of the motion-compensation network.

According to another aspect of the present disclosure, a system for video coding is provided. The system may include a processor and memory storing instructions. The memory storing instructions, which when executed by the processor, may cause the processor to generate optical-flow information based on a current image area and a reference image area. The memory storing instructions, which when executed by the processor, may cause the processor to input the optical-flow information into an entropy-coding network of a motion-compensation network. The entropy-coding network may include at least one GELU layer. The memory storing instructions, which when executed by the processor, may cause the processor to generate a predicted image area as an output of the motion-compensation network.

According to a further aspect of the present disclosure, a non-transitory computer-readable medium storing instructions is provided. The instructions, which when executed by the processor, may cause the processor to generate optical-flow information based on a current image area and a reference image area. The instructions, which when executed by the processor, may cause the processor to input the optical-flow information into an entropy-coding network of a motion-compensation network. The entropy-coding network may include at least one GELU layer. The instructions, which when executed by the processor, may cause the processor to generate a predicted image area as an output of the motion-compensation network.

These illustrative embodiments are mentioned not to limit or define the present disclosure, but to provide examples to aid understanding thereof. Additional embodiments are described in the Detailed Description, and further description is provided there.

### BRIEF DESCRIPTION OF THE DRAWINGS

The accompanying drawings, which are incorporated herein and form a part of the specification, illustrate embodiments of the present disclosure and, together with the description, further serve to explain the principles of the present disclosure and to enable a person skilled in the pertinent art to make and use the present disclosure.

FIG. 1 illustrates a block diagram of an exemplary encoding system, according to some embodiments of the present disclosure.

FIG. 2 illustrates a block diagram of an exemplary decoding system, according to some embodiments of the present disclosure.

FIG. 3 illustrates a detailed block diagram of an exemplary video-coding framework, according to some embodiments of the present disclosure.

FIG. 4 illustrates a first detailed block diagram of an exemplary motion-compensation network that may be included in the video coding framework of FIG. 3, according to some embodiments of the present disclosure.

FIG. 5 illustrates a detailed block diagram of a fast residual channel attention network (FRCAN) that may be included in the motion-compensation network of FIG. 4, according to some embodiments of the present disclosure.

FIG. 6 illustrates a detailed block diagram of an exemplary residual-compensation network that may be included in the video coding framework of FIG. 3, according to some embodiments of the present disclosure.

FIG. 7 illustrates a detailed block diagram of a network architecture of an exemplary residual channel attention hybrid module (RCAHM), according to some embodiments of the present disclosure.

FIG. 8 illustrates a second detailed block diagram of an exemplary motion-compensation network that may be included in the video coding framework of FIG. 3, according to some embodiments of the present disclosure.

FIG. 9 illustrates a graphical representation of a peak-signal-to-noise ratio (PSNR) rate-distortion (RD) performance and the Multi-Scale-Structural SIMilarity (MS-SSIM) RD performance based on an Ultra Video Group (UVG) dataset and a Versatile Video Coding (VVC) dataset obtained using the exemplary video coding framework of FIG. 3, according to some embodiments of the present disclosure.

FIG. 10 illustrates a graphical representation of a PSNR RD performance and MS-SSIM RD performance based on a UVG dataset obtained using video-coding framework of FIG. 3, according to some embodiments of the present disclosure.

FIG. 11 illustrates a flow chart of an exemplary method of video coding, according to some aspects of the present disclosure.

Embodiments of the present disclosure will be described with reference to the accompanying drawings.

### DETAILED DESCRIPTION

Although some configurations and arrangements are discussed, it should be understood that this is done for illustrative purposes only. A person skilled in the pertinent art will recognize that other configurations and arrangements can be used without departing from the spirit and scope of the present disclosure. It will be apparent to a person skilled in the pertinent art that the present disclosure can also be employed in a variety of other applications.

It is noted that references in the specification to “one embodiment,” “an embodiment,” “an example embodiment,” “some embodiments,” “certain embodiments,” etc., indicate that the embodiment described may include a particular feature, structure, or characteristic, but every embodiment may not necessarily include the particular feature, structure, or characteristic. Moreover, such phrases do not necessarily refer to the same embodiment. Further, when a particular feature, structure, or characteristic is described in connection with an embodiment, it would be within the knowledge of a person skilled in the pertinent art to effect such feature, structure, or characteristic in connection with other embodiments whether or not explicitly described.

In general, terminology may be understood at least in part from usage in context. For example, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Various aspects of video coding systems will now be described with reference to various apparatus and methods. These apparatus and methods will be described in the following detailed description and illustrated in the accompanying drawings by various modules, components, circuits, steps, operations, processes, algorithms, etc. (collectively referred to as “elements”). These elements may be implemented using electronic hardware, firmware, computer software, or any combination thereof. Whether such elements are implemented as hardware, firmware, or software depends upon the particular application and design constraints imposed on the overall system.

The techniques described herein may be used for various video coding applications. As described herein, video coding includes both encoding and decoding a video. Encoding and decoding of a video can be performed by the unit of block. For example, an encoding/decoding process such as transform, quantization, prediction, in-loop filtering, reconstruction, or the like may be performed on a coding block, a transform block, or a prediction block. As described herein, a block to be encoded/decoded will be referred to as a “current block.” For example, the current block may represent a coding block, a transform block, or a prediction block according to a current encoding/decoding process. In addition, it is understood that the term “unit” used in the present disclosure indicates a basic unit for performing a specific encoding/decoding process, and the term “block” indicates a sample array of a predetermined size. Unless otherwise stated, the “block,” “unit,” and “component” may be used interchangeably.

Current image compression methods can be divided into two categories: traditional image compression (e.g., JPEG, JPEG2000, BPG) and recent deep learning-based image compression.

Traditional image compression uses module-based encoder/decoder (codec) blocks to remove spatial redundancy and improve image-coding efficiency. To that end, these methods employ a fixed transformation matrix, intra-prediction units, quantization units, adaptive arithmetic encoders, and various deblocking or loop filters. With the rapid development of new image formats and the popularity of high-resolution mobile devices, there is a need to develop a new video coding technology that replaces the existing image compression standards.

For instance, since video content accounts for the vast majority of internet traffic, an efficient video-compression system can generate higher-quality frames under a given bandwidth budget, thereby improving the video transmission speed and viewing experience. In addition, video-compression techniques can also be applied to action recognition and model compression, making video transmission and processing more efficient, saving bandwidth and storage space.

In the past few decades, traditional video standards (such as HEVC and VVC) have used classic prediction, transformation, quantization, and entropy coding frameworks to solve complex video-coding problems. Although these codecs achieve excellent compression efficiency, they also suffer from the following problems: 1) each submodule relies on manual design, making it difficult to optimize the codec from a holistic perspective, and 2) with the emergence of new video application scenarios (e.g., such as 360-degree panoramic videos and virtual reality (VR) videos) traditional video-compression techniques are unable to meet the demands for high-resolution, high-frame rate, and low-latency applications, among others.

The arrival of deep learning has inspired a new wave of development in an end-to-end learning of image and video compression. Compared with traditional algorithms, these methods achieve higher data-compression rates, while maintaining visual performance. To that end, a connection between image-compression systems and a hyperprior model (which led to the development of end-to-end image compression) were developed. Some networks use deep neural networks to reduce temporal and spatial redundancy in video compression. Numerous deep learning-based video encoders and decoders have been proposed, which can be categorized into two main groups: 1) P-frame compression strategies with unidirectional reference and 2) B-frame compression strategies with bidirectional reference.

For P-frame compression, a pixel-motion convolutional neural network (PMCNN), a neural video coding (NVC) network, and a distributed video coding (DVC) network have been developed. To achieve P-frame compression, PMCNN uses motion extension and hybrid prediction networks for P-frame compression, NVC uses joint spatial-temporal prior aggregation, and DVC realizes end-to-end deep video compression by replacing traditional coding modules. These P-frame compression methods use techniques such as optical flow to represent the motion information of the video and compress optical flow and residuals using a variational autoencoder (VAE).

For B-frame compression, allocation strategies and recursive enhancement, interpolation-based video compression networks, and optical-flow compression-networks that simultaneously decode optical flow and interpolation coefficients were developed.

In recent years, the development of learned-image compression (also referred to as “CNN-based image compression”), which is based on a VAE, has achieved better rate-distortion performance than conventional image compression methods in terms of PSNR and MS-SSIM, showing great potential for a practical compression use.

For encoding, the VAE-based image compression methods use linear and nonlinear parametric transforms to map an image into a latent space. After quantization, an entropy estimation model predicts the distributions of latent data, then a lossless context-based adaptive binary arithmetic coding (CABAC) or range coder compresses the latent data into the bit stream. Meanwhile, hyperprior, auto-regressive priors, and Gaussian Mixture Model (GMM) allow the entropy estimation components to precisely predict distributions of latent data and improve RD performance. For decoding, the lossless CABAC or range coder decompresses the bit stream. Then, the decompressed latent data is mapped to reconstructed images by a linear and nonlinear parametric synthesis transform. Combining the above sequential units, those models can be trained end-to-end.

One core problem of existing CNN-based compression methods is that the original convolutional layer is designed for the high-level global feature distillation, rather than the low-level local detail restoration. This inevitably limits further performance improvement.

To overcome these and other challenges of CNN-based compression, the present disclosure provides an exemplary learned video-compression network based on a DVC framework, which is referred to as “hyperprior-based deep video compression (HDVC).” HDVC introduces an improved hyperprior entropy-coding network to the motion-vector compression network to obtain optical-flow results with a greater degree of accuracy. The hyperprior-based entropy-coding network of the residual compression network is further improved using a residual channel-attention hybrid module (RCAHM) and a window attention mechanism. This approach enhances the network's modeling capability for the residual prior information data distribution, resulting in improved reconstruction performance.

Moreover, the present video-coding network described below integrates a simplified FRCAN component and window attention mechanism into the motion-vector compression network to enhance the accuracy of the optical flow output, resulting in more accurate predicted image areas. The RCAHM, which may be included in both the residual-compression and motion-compensation networks, may further improve the accuracy of predicted and reconstructed image areas. In other words, video-coding network of the present disclosure incorporates an exemplary joint application of residual and channel attention mechanisms. Additional details of the exemplary video-coding network are provided below in connection with FIGS. 1-12.

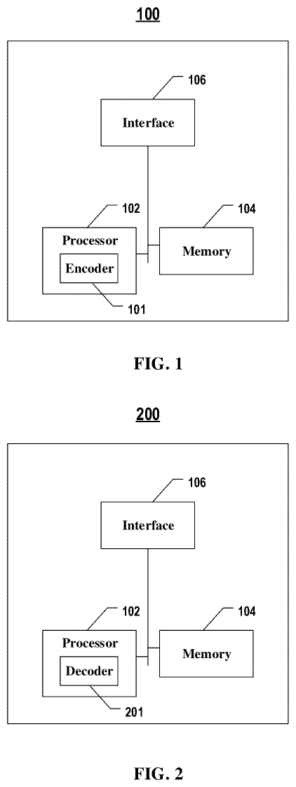

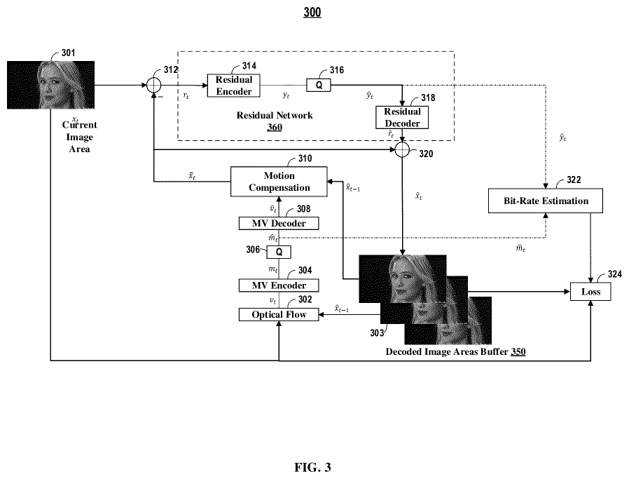

FIG. 1 illustrates a block diagram of an exemplary encoding system 100, according to some embodiments of the present disclosure. FIG. 2 illustrates a block diagram of an exemplary decoding system 200, according to some embodiments of the present disclosure. Each system 100 or 200 may be applied or integrated into various systems and apparatus capable of data processing, such as computers and wireless communication devices. For example, system 100 or 200 may be the entirety or part of a mobile phone, a desktop computer, a laptop computer, a tablet, a vehicle computer, a gaming console, a printer, a positioning device, a wearable electronic device, a smart sensor, a virtual reality (VR) device, an argument reality (AR) device, or any other suitable electronic devices having data processing capability. As shown in FIGS. 1 and 2, system 100 or 200 may include a processor 102, a memory 104, and an interface 106. These components are shown as connected to one another by a bus, but other connection types are also permitted. It is understood that system 100 or 200 may include any other suitable components for performing functions described here.

Processor 102 may include microprocessors, such as graphic processing unit (GPU), image signal processor (ISP), central processing unit (CPU), digital signal processor (DSP), tensor processing unit (TPU), vision processing unit (VPU), neural processing unit (NPU), synergistic processing unit (SPU), or physics processing unit (PPU), microcontroller units (MCUs), application-specific integrated circuits (ASICs), field-programmable gate arrays (FPGAs), programmable logic devices (PLDs), state machines, gated logic, discrete hardware circuits, and other suitable hardware configured to perform the various functions described throughout the present disclosure. Although only one processor is shown in FIGS. 1 and 2, it is understood that multiple processors can be included. Processor 102 may be a hardware device having one or more processing cores. Processor 102 may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. Software can include computer instructions written in an interpreted language, a compiled language, or machine code. Other techniques for instructing hardware are also permitted under the broad category of software.

Memory 104 can broadly include both memory (a.k.a, primary/system memory) and storage (a.k.a. secondary memory). For example, memory 104 may include random-access memory (RAM), read-only memory (ROM), static RAM (SRAM), dynamic RAM (DRAM), ferro-electric RAM (FRAM), electrically erasable programmable ROM (EEPROM), compact disc read-only memory (CD-ROM) or other optical disk storage, hard disk drive (HDD), such as magnetic disk storage or other magnetic storage devices, Flash drive, solid-state drive (SSD), or any other medium that can be used to carry or store desired program code in the form of instructions that can be accessed and executed by processor 102. Broadly, memory 104 may be embodied by any computer-readable medium, such as a non-transitory computer-readable medium. Although only one memory is shown in FIGS. 1 and 2, it is understood that multiple memories can be included.

Interface 106 can broadly include a data interface and a communication interface that is configured to receive and transmit a signal in a process of receiving and transmitting information with other external network elements. For example, interface 106 may include input/output (I/O) devices and wired or wireless transceivers. Although only one memory is shown in FIGS. 1 and 2, it is understood that multiple interfaces can be included.

Processor 102, memory 104, and interface 106 may be implemented in various forms in system 100 or 200 for performing video coding functions. In some embodiments, processor 102, memory 104, and interface 106 of system 100 or 200 are implemented (e.g., integrated) on one or more system-on-chips (SoCs). In one example, processor 102, memory 104, and interface 106 may be integrated on an application processor (AP) SoC that handles application processing in an operating system (OS) environment, including running video encoding and decoding applications. In another example, processor 102, memory 104, and interface 106 may be integrated on a specialized processor chip for video coding, such as a GPU or ISP chip dedicated to image and video processing in a real-time operating system (RTOS).

As shown in FIG. 1, in encoding system 100, processor 102 may include one or more modules, such as an encoder 101 (also referred to herein as a “pre-processing network”). Although FIG. 1 shows that encoder 101 is within one processor 102, it is understood that encoder 101 may include one or more sub-modules that can be implemented on different processors located closely or remotely with each other. Encoder 101 (and any corresponding sub-modules or sub-units) can be hardware units (e.g., portions of an integrated circuit) of processor 102 designed for use with other components or software units implemented by processor 102 through executing at least part of a program, i.e., instructions. The instructions of the program may be stored on a computer-readable medium, such as memory 104, and when executed by processor 102, it may perform a process having one or more functions related to video encoding, such as picture partitioning, inter prediction, intra prediction, transformation, quantization, filtering, entropy encoding, etc., as described below in detail.

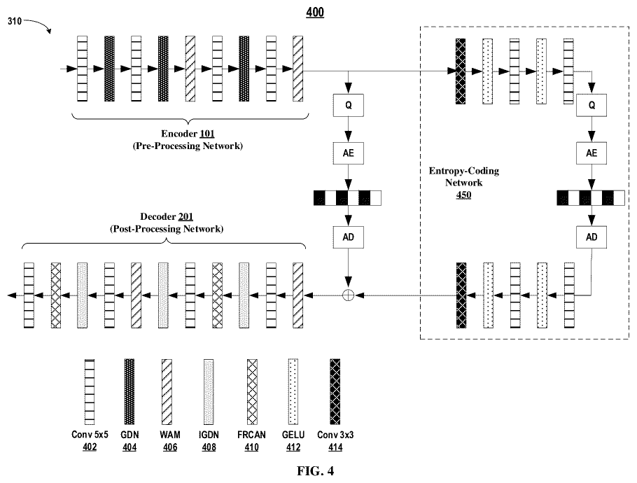

Similarly, as shown in FIG. 2, in decoding system 200, processor 102 may include one or more modules, such as a decoder 201 (also referred to herein as a “post-processing network”). Although FIG. 2 shows that decoder 201 is within one processor 102, it is understood that decoder 201 may include one or more sub-modules that can be implemented on different processors located closely or remotely with each other. Decoder 201 (and any corresponding sub-modules or sub-units) can be hardware units (e.g., portions of an integrated circuit) of processor 102 designed for use with other components or software units implemented by processor 102 through executing at least part of a program, i.e., instructions. The instructions of the program may be stored on a computer-readable medium, such as memory 104, and when executed by processor 102, it may perform a process having one or more functions related to video decoding, such as entropy decoding, inverse quantization, inverse transformation, inter prediction, intra prediction, filtering, as described below in detail. As illustrated in FIG. 3, encoder 101 and decoder 201 may be designed with an asymmetrical coding/decoding framework in that encoder 101 performs standard CNN(s), while decoder 201 employs depth-wise separable convolutional (DSC) network(s).

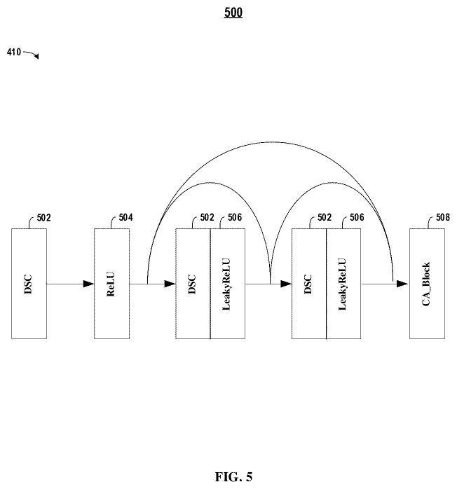

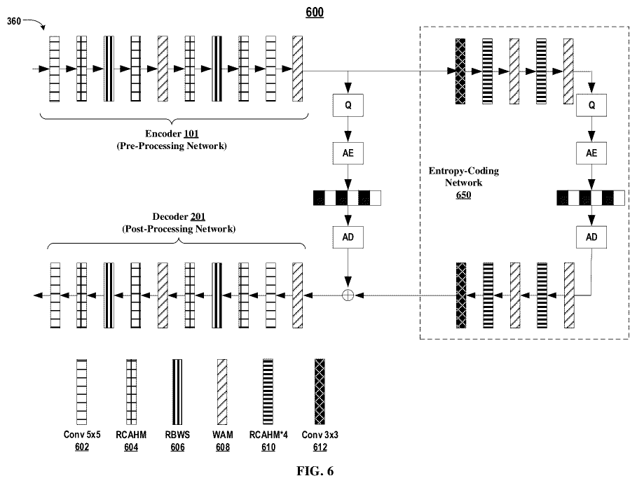

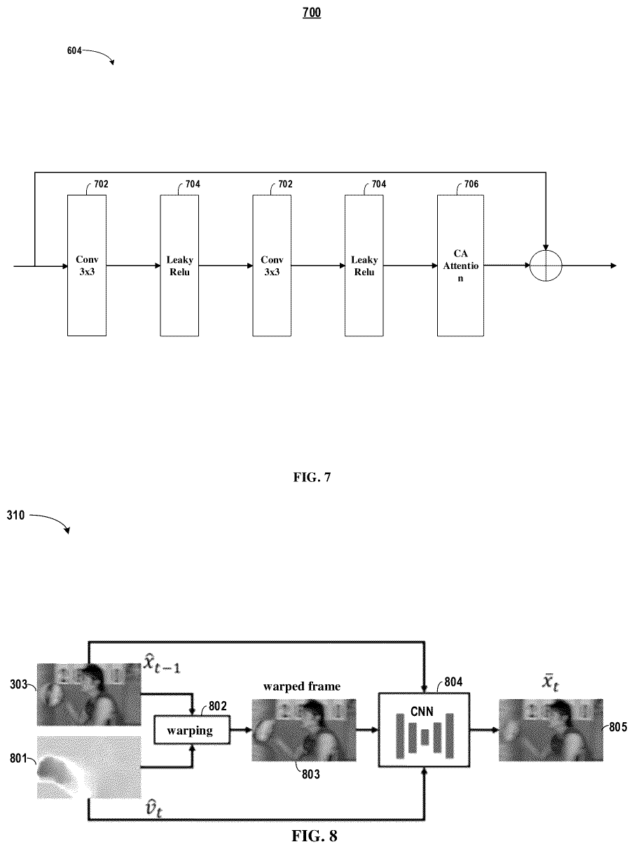

FIG. 3 illustrates a detailed block diagram of an exemplary video-coding network 300 (referred to hereinafter as “video-coding network 300”), according to some embodiments of the present disclosure. FIG. 4 illustrates a first detailed block diagram 400 of motion-compensation network 310 of FIG. 3, according to some embodiments of the present disclosure. FIG. 5 illustrates a detailed block diagram 500 of a FRCAN of motion-compensation network 310 of FIG. 4, according to some embodiments of the present disclosure. FIG. 6 illustrates a detailed block diagram 600 of residual network 360 (e.g., residual encoder 314, residual decoder 318, etc.) of FIG. 3, according to some embodiments of the present disclosure. FIG. 7 illustrates a detailed block diagram of a network architecture 700 of an exemplary residual channel attention hybrid module (RCAHM), according to some embodiments of the present disclosure. FIGS. 3-7 will be described together.

As shown in FIG. 3, video-coding network 300 may implement an HDVC scheme using, e.g., an optical-flow network 302, a motion-vector (MV) encoder network 304, a first quantization (Q) component 306, an MV decoder network 308, a motion-compensation network 310, a first adder 312, a residual encoder 314, a second Q component 316, a residual decoder 318, a second adder 320, a bit-rate estimation-component 322, and a loss-function component 324. Residual encoder 314, second quantization component 316, and residual decoder 318 may form a residual network 360.

To initiate HDVC operations, video-coding network 300 feeds a current image area 301 and (e.g., xₜ) and a reference image area 303 (e.g., \hat{x}ₜ₋₁) into optical-flow network 302 (e.g., a prediction network), which estimates motion of an object in the image areas and extracts relevant information. The optical-flow information (vi) is compressed into a bitstream by MV encoder network 304, first Q component 306, and MV decoder network 308. Then, motion-compensation network 310 produces a predicted image area (xₜ) based on the decoded optical-flow information (11) and reference image area 303. First adder 312 subtracts the predicted image area (x̅ₜ) from the current image area (xₜ) 301 to obtain residual information (ri). Additional details of motion-compensation network 310 will now be provided in connection with FIGS. 4 and 5.

Referring to FIG. 4, motion-compensation network 310 may include, e.g., encoder 101, decoder 201, and entropy-coding network 450. As shown, the encoder and decoder-parts of motion-compensation network 310 may be designed with an asymmetric network structure for learned image compression. The asymmetric network structure provides various advantages. For example, the asymmetric network encoder-decoder structure of motion-compensation network 310 may provide simple encoding that improves the encoding speed and reduces the number of bitstreams. Moreover, the more complex decoding network structure compensates for the information lost by compression and improves the quality of decoded images.

Still referring to FIG. 4, encoder 101 may receive an image from a video. Encoder 101 may include 5×5 convolutional layer(s) 402, generalized divisive normalization (GDN) component(s) 404, and window attention mechanism (WAM) component(s) 406. 5×5 convolutional layer(s) 402 may be responsible for extracting the input image features. GDN component(s) 404 may be used to normalize intermediate features and increase nonlinearity. WAM component(s) 406 (included in encoder 101 and decoder 201) may focus on areas with high contrast and use more bits in these complex areas. In addition, WAM reconstructed images may increase image clarity in terms of texture details. For instance, WAM component(s) 406 help capture long-distance dependencies, even when the input sequence contains noise, thereby capturing important feature-dependencies.

Encoder 101 may output a plurality of feature maps, which may be input into entropy-coding network 450. Entropy-coding network 450 is included in video-coding system 300 so that fewer bitstreams can be used to obtain more accurate optical flow results. Entropy-coding network 450 may include, e.g., 5×5 convolutional component(s) 402, GELU layer(s) 412, and 3×3 convolutional layer(s) 414, for example.

Still referring to FIG. 4, given that the encoding and decoding process of optical-flow vectors is similar to that of end-to-end image compression, entropy-coding network 450 may apply prior knowledge to better describe the data distribution of motion vectors and minimize information loss while ensuring the application's compression ratio. Additionally, a Gaussian error linear unit (GELU) layer 412 (e.g., an activation function) is included in entropy-coding network 450 rather than a rectified linear unit (ReLU) activation function to better address the problem of gradient explosion. Modifying the activation function of entropy-coding network 450 with GELU layer(s) 412 rather than ReLU layer(s) has various advantages. For example, GELU layer(s) 412 improves convergence and can train deep the neural networks of video-coding system 300 faster than a ReLU layer. Moreover, GELU layer(s) 412 improves the system's non-linear representation ability and capture complex patterns with a greater degree of accuracy. Thus, the ReLU layer of conventional entropy-coding networks is replaced with GELU layer(s) 412 to accelerate the model training speed, and to better cope with the possible gradient explosion problem.

Referring to FIG. 4, after entropy modeling, the feature maps may be input into decoder 201. Decoder 201 may include, e.g., 5×5 convolutional layer(s) 402, WAM component(s) 406, inverse generalized division normalization (IGDN) component(s) 408, and FRCAN component(s) 410. WAM component(s) 406 and FRCAN component(s) 410 are included in decoder 201 to improve feature-extraction and reconstruction capabilities of motion-compensation network 310. The dynamic details and visual quality of the video image areas captured by the optical-flow information may be improved with the use of WAM component(s) 406 and FRCAN component(s) 410. Since video-coding network 300 adopts a holistic end-to-end training approach and trains multiple networks simultaneously, FRCAN component(s) 410 (which are included in decoder 201) may use simple convolutional neural networks to up-sample and down-sample the optical-flow information to save computational resources. Moreover, in terms of decoding efficiency, FRCAN component(s) 410 may improve the decoding accuracy and processing speed, as compared to conventional decoders. Additional details of FRCAN component(s) 410 will now be provided in connection with FIG. 5.

For instance, referring to FIG. 5, the convolutional layer in front of CA layer 508 is replaced with a simplified residual-in-residual dense block (RRDB). Using a dense residual structure, FRCAN component(s) 410 may generate additional and informative image features to compensate for feature loss during compression. This improves the quality of the image generated after decompression. The dense residual structure may include, e.g., a plurality of DSC networks 502, a ReLU layer 504, and a plurality of Leaky ReLU layers 506. Four residual channel attention blocks (RCABs) (as compared to twelve RCABs in other systems) may be combined to form one FRCAN component 410, which achieves runtime reduction and quality enhancement.

Still referring to FIG. 5, since DSC networks 502 applies around one third of parameters of standard convolution, DSC networks 502 increases the computational speed of video-coding network 300, while providing network stability. Including DSC networks 502 in FRCAN component(s) 410 reduces the number of generated bitstreams, while still capturing the informative features, thereby leading to an improvement in terms of runtime and visual quality.

Referring again to FIG. 4, the network architecture of entropy-coding network 450 may be optimized using a conditional context based on a channel and residual prediction module of potential representation(s). By optimizing entropy-coding network 450, improved RD performance may be achieved, as compared to the existing context-entropy modeling, while at the same time minimizing serial processing.

Referring again to FIG. 3, residual encoder 314 compresses the residual image area (rₜ) using the residual encoding and decoding network (shown in FIG. 6), generating another bitstream (yₜ). After quantization, a quantized bitstream (ŷₜ) is input into residual decoder 318, which outputs decoded residual information (\hat{r}ₜ) (a decoded residual image area). Finally, the decoded residual information (\hat{r}ₜ) is combined with the predicted image area (x̅ₜ) by second adder 320 to obtain a fully reconstructed image area (\hat{x}ₜ), which is stored in decoded image areas buffer 350. Additional details of the residual-compression network (e.g., made up of residual encoder 314, residual decoder 318, etc.) will now be described in connection with FIGS. 6 and 7.

Referring to FIG. 6, in video compression, there is a high degree of similarity between predicted image areas and adjacent image areas, which means that low-frequency residual information is usually well-preserved in the predicted image area (\hat{x}ₜ). Therefore, the present compression network prioritizes the efficient compression and transmission of high-frequency residual information. To that end, the present disclosure incorporates the symmetrically compressed autoencoder structure in residual network 360. Residual network 360 may include, e.g., 5×5 convolutional layer(s) 602, RCAHM component(s) 604, residual block with stride (RBWS) component(s) 606, WAM component(s) 608, four RCAHM (RCAHM*4) component(s) 610 (included in entropy-coding network 650), and 3×3 convolutional layer(s) 612 (included in entropy-coding network 650).

Referring to FIG. 6, residual network 360 incorporates a large number of residual and attention mechanisms to filter and enhance residual information before compression during the encoding stage. Additionally, these mechanisms are also utilized during decoding to recover and select residual information, resulting in higher-quality reconstructed image areas. To enhance the adaptive ability and feature extraction capability of the entropy encoder, residual modules and attention mechanisms are also introduced into the entropy-coding network 650. This improves compression quality and captures the details of the residual information's structural probability distribution more effectively.

Furthermore, due to the limited computational resources, it is not feasible to use a large-scale dense residual network simultaneously at the encoding and decoding stages to enhance and recover residual information. Thus, residual channel attention hybrid module (RCAHM) component(s) 604 may be included in the residual encoder and decoder to improve the accuracy of residual information, additional details of which are provided below in connection with FIG. 7.

For instance, referring to FIG. 7, a channel attention layer 706 is integrated into the traditional residual network. For example, RCAHM component(s) 604 may include, e.g., 3×3 convolutional layer(s) 702, leaky ReLU layer(s) 704, and a channel attention (CA) layer 706. The workflow of RCAHM component(s) 604 may include the following operations: 1) convolve the input information using a 3×3 convolution layer 702 to generate more features, 2) CA layer 706 assigns weights to these features and combines them with the input information. The process selectively preserves or eliminates residual information from input, which enhances and restores crucial residual features.

FIG. 8 illustrates a second detailed block diagram of an exemplary motion-compensation network 800 that may be included in motion-compensation network 310 of FIG. 3, according to some embodiments of the present disclosure.

Motion-compensation network 310 may warp the reference image area 303 (\hat{x}ₜ₋₁) to the current image area 301 (xₜ) according to the motion-vector information D. The warped image area w (\hat{x}ₜ₋₁, \hat{v}) may still have artifacts. To eliminate the artifacts, the DVC technique employed by motion-compensation network 310 may connects the warped image area w(\hat{x}ₜ₋₁, \hat{v}), the reference image area \hat{x}ₜ₋₁ and the motion-vector information \hat{v}. as input, and then inputs them into another CNN 804 to obtain a refined predicted image area x̅ₜ. To enhance the accuracy of predicted image area 805, the ordinary residual layers of CNN component 804 are replaced with RCAHM component(s) 604, which aids in generating and retaining crucial features for predicted image areas.

Referring again to FIG. 3, by training video-coding network 300 using an asymmetric encoder 101 and decoder 201, different properties may be balanced to minimize the loss function, which is a weighted sum of the terms measuring image reconstruction quality and the compression rate.

For instance, video-coding network 300 may be trained under bandwidth-constrained conditions. Thus, a means-square error (MSE) loss function may be selected because it may use fewer computational resources and smaller bandwidth. An MSE loss function may also be used to calculate the average pixel-difference between compressed video image areas and original video image areas. It can also be used to calculate the difference between each image area. The loss function [symbol] of the image compression model generated by video-coding network 300 may be represented by expression (1) shown below.

$$ℒ = R + λ \cdot D = λ d ( {x}_{t} , {\hat{x}}_{t} ) + ( H ( {\hat{m}}_{t} ) + H ( {\hat{y}}_{t} ) ) , \qquad ( 1 )$$

where λ is a Lagrange multiplier that controls the trade-off between compression rate and distortion, R is the bit-rate of latent data ŷ and \hat{z}, d(x, \hat{x}) is the distortion between the raw image x and the reconstructed image \hat{x}, H(·) represents the number of bits used for encoding the representations. In the present approach, both residual representation mt and motion representation m, may be encoded into the bitstreams, as shown in FIG. 3.

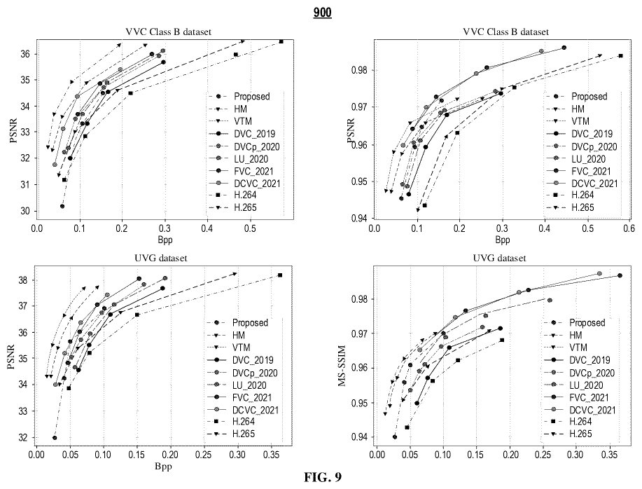

FIG. 9 illustrates a graphical representation 900 of a PSNR RD performance and the MS-SSIM RD performance based on a UVG dataset and a VVC dataset obtained using video-coding network 300 of FIG. 3, according to some embodiments of the present disclosure. With respect to PSNR, HDVC outperforms DVC and the others in most bit-rate ranges, while it is only slightly worse than deep-contextual video coding (DCVC), HEVC test model (HM) coding, and VVC test model (VTM) coding at a full bit-rate. However, in MS-SSIM, HDVC is only slightly inferior to DCVC, future video coding (FVC), HM coding, and VTM coding. Compared with the other methods, HDVC exhibits superior performance. As shown in FIG. 9, the PSNR performance of HDVC slightly decreases when using VVC Class B testing dataset. The decrease is from the low frame-rate of the VVC test dataset, e.g., 50 or 60 frames-per-second (fps). For reference, the UVG test dataset has high frame rate of 120 fps. However, in MS-SSIM, HDVC outperforms most deep learning-based video compression methods, except for DCVC and FVC, and outperforms HM and VTM at a high bit-rate. These results show that HDVC can achieve a better structural recovery on low frame-rate videos.

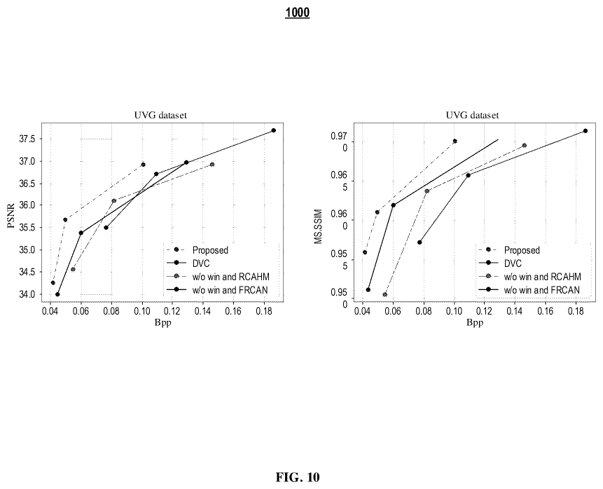

FIG. 10 illustrates a graphical representation 1000 of a PSNR RD performance and MS-SSIM RD performance based on a UVG dataset obtained using video-coding framework of FIG. 3, according to some embodiments of the present disclosure. Referring to FIG. 10, the results of two ablation experiments are shown. The ablation experiments include the following. First, the window attention mechanism (W/O win) and FRCAN component(s) are removed from the proposed optical-flow network. Next, using the optical-flow network and the front-end and back-end processing parts of the residual-compression network proposed by DVC, the RCAHM component(s) and window attention mechanism are retained in the entropy encoding part of the residual compression network. Then, the performance of the two models is evaluated to verify the effectiveness of the window attention mechanism, the FRCAN component(s), and the RCAHM component(s).

Still referring to FIG. 10, the W/O win and FRCAN network exhibit significant PSNR and MS-SSIM losses at medium to high bit-rate compared with HDVC. This indicates that the integration of the window attention mechanism and the FRCAN component(s) in the optical-flow network improves the performance of optical-flow estimation, which improves the accuracy of the predicted image areas. Furthermore, the results of the W/O win and RCAHM network show that RCAHM component(s) and window attention mechanism in the prior-knowledge based entropy-coding network can effectively restore the structural features of reconstructed image areas, thus leading to an improvement in visual quality over DVC.

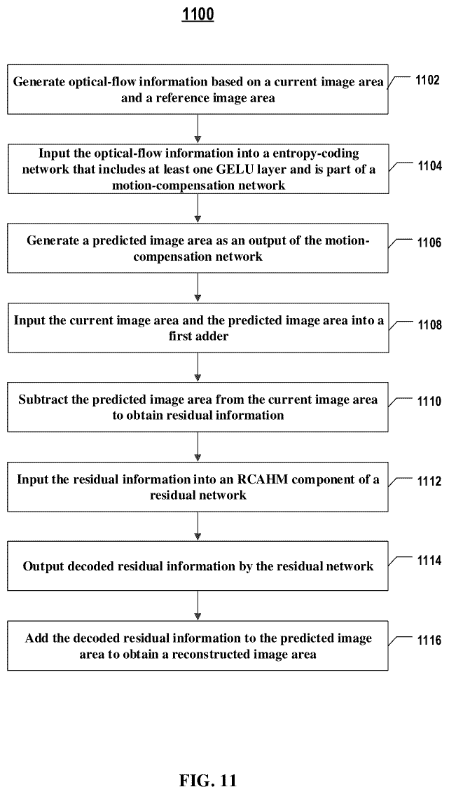

FIG. 11 illustrates a flow chart of an exemplary method 1100 of video encoding, according to some embodiments of the present disclosure. Method 1100 may be performed by an apparatus, e.g., such as encoder 101, decoder 201, video-coding network 300, optical-flow network 302, MV encoder network 304, first quantization component 306, MV decoder network 308, motion compensation network 310, first adder 312, residual encoder 314, second quantization component 316, residual decoder 318, second adder 320, or residual network 360, or any other suitable video decoding and/or compression systems. Method 1100 may include operations 1102-1116 as described below. It is understood that some of the operations may be optional, and some of the operations may be performed simultaneously, or in a different order other than shown in FIG. 11.

At 1102, the system may generate optical-flow information based on a current image area and a reference image area. For example, referring to FIG. 3, to initiate HDVC operations, video-coding network 300 feeds a current image area 301 and (e.g., xₜ) and a reference image area 303 (e.g., \hat{x}ₜ₋₁) into optical-flow network 302 (e.g., a prediction network), which estimates the motion of an object in the image areas and extracts relevant information. The optical-flow information (vₜ) is generated as a compressed bitstream by MV encoder network 304, first Q component 306, and MV decoder network 308. Once compressed, the optical-flow information (vₜ) is input into motion-compensation network 310.

At 1104, the system may input the optical-flow information into an entropy-coding network that includes at least one GELU layer and is part of a motion-compensation network. For example, referring to FIGS. 3-5, motion-compensation network 310 may include, e.g., encoder 101, decoder 201, and entropy-coding network 450. Encoder 101 may receive an image from a video. Encoder 101 may include 5×5 convolutional layer(s) 402, GDN component(s) 404, and WAM component(s) 406. 5×5 convolutional layer(s) 402 may be responsible for extracting the input image features. GDN component(s) 404 may be used to normalize intermediate features and increase nonlinearity. WAM component(s) 406 may focus on areas with high contrast and use more bits in these complex areas. In addition, WAM reconstructed images may increase image clarity in terms of texture details. Encoder 101 may output a plurality of feature maps, which may be input into entropy-coding network 450. Still referring to FIG. 4, given that the encoding and decoding process of optical-flow vectors is similar to that of end-to-end image compression, entropy-coding network 450 may apply prior knowledge to better describe the data distribution of motion vectors and minimize information loss while ensuring the application's compression ratio. Additionally, a GELU layer(s) 412 (e.g., an activation function) is included in entropy-coding network 450 rather than a ReLU activation function to better address the problem of gradient explosion. Referring to FIG. 4, after entropy modeling, the feature maps may be input into decoder 201. Decoder 201 may include, e.g., 5×5 convolutional layer(s) 402, WAM component(s) 406, IGDN component(s) 408, and FRCAN component(s) 410. WAM component(s) 406 and FRCAN component(s) 410 are included in decoder 201 to improve feature-extraction and reconstruction capabilities of motion-compensation network 310. The dynamic details and visual quality of the video image areas captured by the optical-flow information may be improved with the use of WAM component(s) 406 and FRCAN component(s) 410. Since video-coding network 300 adopts a holistic end-to-end training approach and trains multiple networks simultaneously, FRCAN component(s) 410 may use simple convolutional neural networks to up-sample and down-sample the optical-flow information to save computational resources. Additional details of FRCAN component(s) 410 will now be provided in connection with FIG. 5. For instance, referring to FIG. 5, the convolutional layer in front of CA layer 508 is replaced with a simplified residual-in-residual dense block (RRDB). Using a dense residual structure, FRCAN component(s) 410 may generate additional and informative image features to compensate for feature loss during compression. This improves the quality of the image generated after decompression. The dense residual structure may include, e.g., a plurality of DSC networks 502, a ReLU layer 504, and a plurality of Leaky ReLU layers 506. Four RCABs (as compared to twelve RCABs in other systems) may be combined to form one FRCAN component 410, which achieves runtime reduction and quality enhancement. Referring again to FIG. 4, the network architecture of entropy-coding network 450 may be optimized using a conditional context based on a channel and residual prediction module of potential representation(s). By optimizing entropy-coding network 450, improved RD performance may be achieved, as compared to the existing context-entropy modeling, while at the same time minimizing serial processing.

At 1106, the system may generate a predicted image area as an output of the motion-compensation network. In some embodiments, to generate the predicted image area as the output of the motion-compensation network, the memory storing instructions, which when executed by the processor, cause the processor to warp the reference image area with the optical-flow information to generate a warped image area. In some embodiments, to generate the predicted image area as the output of the motion-compensation network, the memory storing instructions, which when executed by the processor, cause the processor to input the warped image area into a neural network that includes an RCAHM component. In some embodiments, the predicted image area may be generated as an output of the neural network. For example, referring to FIGS. 3 and 8, motion-compensation network 310 produces a predicted image area (x+) based on the decoded optical-flow information (01) and reference image area 303. Referring to FIG. 8, motion-compensation network 800 includes a warping component 802, which warps the position of current image area 301 by applying motion vectors 801 (\hat{v}ₜ) to reference image area 303. Subsequently, the warped image area 803, reference image area 303, and motion vectors 801 are supplied to a CNN component 804. CNN component 804 may generate the predicted image area 805 (x̅ₜ). To enhance the accuracy of predicted image area 805, the ordinary residual layers of CNN component 804 are replaced with the RCAHM component(s) 604, which aims to generate and retain crucial features for predicted image areas.

At 1108, the system may input the current image area and the predicted image area into a first adder. For example, referring to FIG. 3, the current image area (xₜ) and the predicted image area (x̅ₜ) may be input to first adder 312 by video-coding network 300 and motion-compensation network 310, respectively.

At 1110, the system may subtract the predicted image area from the current image area to obtain residual information. For example, referring to FIG. 3, first adder 312 subtracts the predicted image area (x̅ₜ) from the current image area (xₜ) 301 to obtain residual information (rₜ).

At 1112, the system may input the residual information into an RCAHM component of a residual network. For example, referring to FIGS. 3 and 6, residual information (rₜ) may be input into residual network 360, which includes one or more RCAHM component(s) 604.

At 1114, the system may output decoded residual information by the residual network. For example, referring to FIG. 3, residual encoder 314 compresses the residual image area (rₜ) using the residual encoding and decoding network (shown in FIG. 6), generating another bitstream (yₜ). After quantization, a quantized bitstream (ŷₜ) is input into residual decoder 318, which outputs decoded residual information (\hat{r}ₜ) (a decoded residual image area). In video compression, there is a high degree of similarity between predicted image areas and adjacent image areas, which means that low-frequency residual information is usually well-preserved in the predicted image area (x̅ₜ). Therefore, the present compression network prioritizes the efficient compression and transmission of high-frequency residual information. To that end, the present disclosure incorporates the symmetrically compressed autoencoder structure of residual network 360 into video-coding network 300. Referring to FIG. 6, residual network 360 incorporates a large number of residual and attention mechanisms to filter and enhance residual information before compression during the encoding stage. Additionally, these mechanisms are also utilized during decoding to recover and select residual information, resulting in higher-quality reconstructed image areas. To enhance the adaptive ability and feature extraction capability of the entropy encoder, residual modules and attention mechanisms are also introduced into the entropy-coding network 650. This improves compression quality and captures the details of the residual information's structural probability distribution more effectively. Furthermore, due to the limited computational resources, it is not feasible to use a large-scale dense residual network simultaneously at the encoding and decoding stages to enhance and recover residual information. Thus, RCAHM component(s) 604 may be included in the residual encoder and decoder to improve the accuracy residual information, additional details of which are provided below in connection with FIG. 7. For instance, referring to FIG. 7, a channel attention layer 706 is integrated into the traditional residual network. For example, RCAHM component(s) 604 may include, e.g., 3×3 convolutional layer(s) 704, leaky ReLU layer(s) 704, and a channel attention (CA) layer 706. The workflow of RCAHM component(s) 604 may include the following operations: 1) convolve the input information using a 3×3 convolution layer 702 to generate more features, 2) CA layer 706 assigns weights to these features and combines them with the input information. The process selectively preserves or eliminates residual information from input, which enhances and restores crucial residual features.

At 1116, the system may add the decoded residual information to the predicted image area to obtain a reconstructed image area. For example, referring to FIG. 3, the decoded residual information (ft) is combined with the predicted image area (xₜ) by second adder 320 to obtain a fully reconstructed image area (\hat{x}ₜ), which is stored in decoded image areas buffer 350.

In various aspects of the present disclosure, the functions described herein may be implemented in hardware, software, firmware, or any combination thereof. If implemented in software, the functions may be stored as instructions on a non-transitory computer-readable medium. Computer-readable media includes computer storage media. Storage media may be any available media that can be accessed by a processor, such as processor 102 in FIGS. 1 and 2. By way of example, and not limitation, such computer-readable media can include RAM, ROM, EEPROM, CD-ROM or other optical disk storage, HDD, such as magnetic disk storage or other magnetic storage devices, Flash drive, SSD, or any other medium that can be used to carry or store desired program code in the form of instructions or data structures and that can be accessed by a processing system, such as a mobile device or a computer. Disk and disc, as used herein, includes CD, laser disc, optical disc, digital video disc (DVD), and floppy disk where disks usually reproduce data magnetically, while discs reproduce data optically with lasers. Combinations of the above should also be included within the scope of computer-readable media.

According to one aspect of the present disclosure, a method of video coding is provided. The method may include generating, by a processor, optical-flow information based on a current image area and a reference image area. The method may include inputting, by the processor, the optical-flow information into an entropy-coding network of a motion-compensation network. The entropy-coding network may include at least one GELU layer. The method may include generating, by the processor, a predicted image area as an output of the motion-compensation network.

In some embodiments, the generating, by the processor, the predicted image area as the output of the motion-compensation network may include warping the reference image area with the optical-flow information to generate a warped image area. In some embodiments, the generating, by the processor, the predicted image area as the output of the motion-compensation network may include inputting the warped image area into a neural network that includes an RCAHM component. In some embodiments, the predicted image area may be generated as an output of the neural network.

In some embodiments, the method may include inputting, by the processor, the current image area and the predicted image area into a first adder. In some embodiments, the method may include subtracting, by the processor, the predicted image area from the current image area to obtain residual information.

In some embodiments, the method may include inputting, by the processor, the residual information into an RCAHM component of a residual network.

In some embodiments, the RCAHM component may include a plurality of convolutional layers and a channel attention layer.

In some embodiments, the method may include outputting, by the processor, decoded residual information by the residual network.

In some embodiments, the method may include adding, by the processor, the decoded residual information to the predicted image area to obtain a reconstructed image area.

In some embodiments, the image area may be associated with a picture, a sub-picture, a tile, a slice, or a coding block.

According to another aspect of the present disclosure, a system for video coding is provided. The system may include a processor and memory storing instructions. The memory storing instructions, which when executed by the processor, may cause the processor to generate optical-flow information based on a current image area and a reference image area. The memory storing instructions, which when executed by the processor, may cause the processor to input the optical-flow information into a entropy-coding network of a motion-compensation network. The entropy-coding network may include at least one GELU layer. The memory storing instructions, which when executed by the processor, may cause the processor to generate a predicted image area as an output of the motion-compensation network.

In some embodiments, to generate the predicted image area as the output of the motion-compensation network, the memory storing instructions, which when executed by the processor, cause the processor to warp the reference image area with the optical-flow information to generate a warped image area. In some embodiments, to generate the predicted image area as the output of the motion-compensation network, the memory storing instructions, which when executed by the processor, cause the processor to input the warped image area into a neural network that includes an RCAHM component. In some embodiments, the predicted image area may be generated as an output of the neural network.

In some embodiments, the memory storing instructions, which when executed by the processor, further cause the processor to input the current image area and the predicted image area into a first adder. In some embodiments, the memory storing instructions, which when executed by the processor, further cause the processor to subtract the predicted image area from the current image area to obtain residual information.

In some embodiments, the memory storing instructions, which when executed by the processor, further cause the processor to input the residual information into an RCAHM component of a residual network.

In some embodiments, the RCAHM component may include a plurality of convolutional layers and a channel attention layer.

In some embodiments, the memory storing instructions, which when executed by the processor, further cause the processor to output decoded residual information by the residual network.

In some embodiments, the memory storing instructions, which when executed by the processor, further cause the processor to add the decoded residual information to the predicted image area to obtain a reconstructed image area.

In some embodiments, the image area may be associated with a picture, a sub-picture, a tile, a slice, or a coding block.

According to a further aspect of the present disclosure, a non-transitory computer-readable medium storing instructions is provided. The instructions, which when executed by the processor, may cause the processor to generate optical-flow information based on a current image area and a reference image area. The instructions, which when executed by the processor, may cause the processor to input the optical-flow information into an entropy-coding network of a motion-compensation network. The entropy-coding network may include at least one GELU layer. The instructions, which when executed by the processor, may cause the processor to generate a predicted image area as an output of the motion-compensation network.

In some embodiments, to generate the predicted image area as the output of the motion-compensation network, the instructions, which when executed by the processor, cause the processor to warp the reference image area with the optical-flow information to generate a warped image area. In some embodiments, to generate the predicted image area as the output of the motion-compensation network, the instructions, which when executed by the processor, cause the processor to input the warped image area into a neural network that includes an RCAHM component. In some embodiments, the predicted image area may be generated as an output of the neural network.

In some embodiments, the instructions, which when executed by the processor, further cause the processor to input the current image area and the predicted image area into a first adder. In some embodiments, the instructions, which when executed by the processor, further cause the processor to subtract the predicted image area from the current image area to obtain residual information.

In some embodiments, the instructions, which when executed by the processor, further cause the processor to input the residual information into an RCAHM component of a residual network.

In some embodiments, the RCAHM component may include a plurality of convolutional layers and a channel attention layer.

In some embodiments, the instructions, which when executed by the processor, further cause the processor to output decoded residual information by the residual network.

In some embodiments, the instructions, which when executed by the processor, further cause the processor to add the decoded residual information to the predicted image area to obtain a reconstructed image area.

In some embodiments, the image area may be associated with a picture, a sub-picture, a tile, a slice, or a coding block.

The foregoing description of the embodiments will so reveal the general nature of the present disclosure that others can, by applying knowledge within the skill of the art, readily modify and/or adapt for various applications such embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

Embodiments of the present disclosure have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The Summary and Abstract sections may set forth one or more but not all exemplary embodiments of the present disclosure as contemplated by the inventor(s), and thus, are not intended to limit the present disclosure and the appended claims in any way.

Various functional blocks, modules, and steps are disclosed above. The arrangements provided are illustrative and without limitation. Accordingly, the functional blocks, modules, and steps may be reordered or combined in different ways than in the examples provided above. Likewise, some embodiments include only a subset of the functional blocks, modules, and steps, and any such subset is permitted.

The breadth and scope of the present disclosure should not be limited by any of the above-described exemplary embodiments, but should be defined only in accordance with the following claims and their equivalents.

What is claimed is:

1. A method of video coding, comprising:
generating, by a processor, optical-flow information based on a current image area and a reference image area;
inputting, by the processor, the optical-flow information into an entropy-coding network of a motion-compensation network, the entropy-coding network including at least one Gaussian error linear unit (GELU) layer; and
generating, by the processor, a predicted image area as an output of the motion-compensation network.

2. The method of claim 1, wherein the generating, by the processor, the predicted image area as the output of the motion-compensation network comprises:
warping the reference image area with the optical-flow information to generate a warped image area; and
inputting the warped image area into a neural network that includes a residual channel attention hybrid module (RCAHM) component,
wherein the predicted image area is generated as an output of the neural network.

3. The method of claim 1, further comprising:
inputting, by the processor, the current image area and the predicted image area into a first adder; and
subtracting, by the processor, the predicted image area from the current image area to obtain residual information.

4. The method of claim 3, further comprising:
inputting, by the processor, the residual information into a residual channel attention hybrid module (RCAHM) component of a residual network.

5. The method of claim 4, wherein the RCAHM component includes a plurality of convolutional layers and a channel attention layer.

6. The method of claim 4, further comprising:
outputting, by the processor, decoded residual information by the residual network.

7. The method of claim 6, further comprising:
adding, by the processor, the decoded residual information to the predicted image area to obtain a reconstructed image area.

8. The method of claim 1, wherein the image area is associated with a picture, a sub-picture, a tile, a slice, or a coding block.

9. A system for video coding, comprising:
a processor; and
memory storing instructions, which when executed by the processor, cause the processor to:
generate optical-flow information based on a current image area and a reference image area;
input the optical-flow information into an entropy-coding network of a motion-compensation network, the entropy-coding network including at least one Gaussian error linear unit (GELU) layer; and
generate a predicted image area as an output of the motion-compensation network.

10. The system of claim 9, wherein, to generate the predicted image area as the output of the motion-compensation network, the memory storing instructions, which when executed by the processor, cause the processor to:
warp the reference image area with the optical-flow information to generate a warped image area; and
input the warped image area into a neural network that includes a residual channel attention hybrid module (RCAHM) component,
wherein the predicted image area is generated as an output of the neural network.

11. The system of claim 9, wherein the memory storing instructions, which when executed by the processor, further cause the processor to:
input the current image area and the predicted image area into a first adder; and
subtract the predicted image area from the current image area to obtain residual information.

12. The system of claim 11, wherein the memory storing instructions, which when executed by the processor, further cause the processor to:
input the residual information into a residual channel attention hybrid module (RCAHM) component of a residual network.

13. The system of claim 12, wherein the RCAHM component includes a plurality of convolutional layers and a channel attention layer.

14. The system of claim 12, wherein the memory storing instructions, which when executed by the processor, further cause the processor to:
output decoded residual information by the residual network.

15. The system of claim 14, wherein the memory storing instructions, which when executed by the processor, further cause the processor to:
add the decoded residual information to the predicted image area to obtain a reconstructed image area.

16. The system of claim 9, wherein the image area is associated with a picture, a sub-picture, a tile, a slice, or a coding block.

17. A non-transitory computer-readable medium storing instructions, which when executed by a processor of a video-coding system, cause the processor to:
generate optical-flow information based on a current image area and a reference image area;
input the optical-flow information into a entropy-coding network of a motion-compensation network, the entropy-coding network including at least one Gaussian error linear unit (GELU) layer; and
generate a predicted image area as an output of the motion-compensation network.

18. The non-transitory computer-readable medium of claim 17, wherein, to generate the predicted image area as the output of the motion-compensation network, the instructions, which when executed by the processor, cause the processor to:
warp the reference image area with the optical-flow information to generate a warped image area; and
input the warped image area into a neural network that includes a residual channel attention hybrid module (RCAHM) component,
wherein the predicted image area is generated as an output of the neural network.

19. The non-transitory computer-readable medium of claim 17, wherein the instructions, which when executed by the processor of the video-coding system, further cause the processor to:
input the current image area and the predicted image area into a first adder; and
subtract the predicted image area from the current image area to obtain residual information.

20. The non-transitory computer-readable medium of claim 19, wherein the instructions, which when executed by the processor of the video-coding system, further cause the processor to:
input the residual information into a residual channel attention hybrid module (RCAHM) component of a residual network,
wherein the RCAHM component includes a plurality of convolutional layers and a channel attention layer;
wherein the instructions, which when executed by the processor of the video-coding system, further cause the processor to:
output decoded residual information by the residual network.
